(19) United States
(12) Patent Application Publication
(10) Pub. No.: US 2022/0287169 A1
(43) Pub. Date: Sep. 8, 2022

(54) LAMP WITH REMOTE CONTROL SIGNAL PROCESSING CIRCUIT

(71) Applicant: LED STAR LIGHTING TECHNOLOGY CO.,LTD, Zhongshan (CN)

(72) Inventor: Pingzhi Yang, Dongkou (CN)

(73) Assignee: LED STAR LIGHTING TECHNOLOGY CO.,LTD, Zhongshan (CN)

(21) Appl. No.: 17/709,447

(22) Filed: Mar. 31, 2022

(30) Foreign Application Priority Data
Mar. 5, 2022 (CN) 202210211224.1

(51) Int. Cl. H05B 47/19; G08C 17/02; F21V 33/00

(52) U.S. Cl. CPC H05B 47/19; G08C 17/02; F21V 33/0096

(57) ABSTRACT

The present disclosure discloses a lamp with a remote control signal processing circuit, and relates to the technical field of lamps. The present disclosure includes a wireless control module, a motor driving module connected with the wireless control module, and a lamp driving module connected with the wireless control module. The lamp driving module is connected in parallel with the motor driving module. In the present disclosure, received remote control signals are processed by one wireless receiving module in a unified manner, and an alternating-current (AC) signal is subjected to protocol control; and the AC signal is transmitted to the lamp driving circuit to adjust light, so that the cost is reduced, and the circuit volume is reduced.

### TECHNICAL FIELD

The present disclosure belongs to the technical field of lamps, and particularly relates to a lamp with a remote control signal processing circuit.

### BACKGROUND ART

A fan lamp includes two parts: a fan and a lamp. The remote control fan and lamp have their own corresponding drive and remote control signal processing modules. Generally, the driving of the lamp and the fan is not achieved on a driving plate. Therefore, in the prior art, independent remote control receiving and processing modules are respectively used for controlling the lamp and the fan, respectively. As a result, the fan lamp has high cost, large volume, and complicated circuit.

### SUMMARY

The present disclosure aims to provide a lamp with a remote control signal processing, circuit, which solves the technical problems that a fan lamp in the prior art has high cost, large volume, and, complicated circuit.

In order to achieve the foregoing purposes, the present disclosure is implemented through the following technical solutions:

A lamp with a remote, control signal processing circuit includes a wireless control module, a motor driving module connected with the wireless control module, and a lamp driving module connected with the wireless control module. The lamp driving module is connected in parallel with the motor driving module.

Optionally, the wireless control module includes a remote control signal sending module.

Optionally, the remote control signal sending module is connected with a signal, receiving module; and the signal receiving module is connected with a signal decoding module.

Optionally, the signal decoding module is connected with a received signal conversion module; and the received signal conversion module is connected with an AC signal processing module.

Optionally, the AC signal processing module is connected with an AC signal sampling module; and the AC signal sampling module is connected with a sampled signal processing module.

Optionally, the sampled signal processing module is connected with a lamp driving display module.

The embodiment of the present disclosure has the following beneficial effects:

In one embodiment of the present disclosure, received remote control signals are processed by one wireless receiving module in a unified manner, and an AC signal is subjected to protocol control; and the AC signal is transmitted to the lamp driving circuit to adjust light, so that the cost is reduced, and the circuit volume is reduced. The present disclosure can convert the received remote control signals into protocol signals, and sample the AC signal through the protocol signals to generate a dimming control signal; and a color temperature level and luminous intensity of a lamp panel can be controlled without adding a remote control receiving and processing circuit on a lamp driving plate.

Of course, it is not necessary for any product implementing the present disclosure to achieve all of the above advantages simultaneously.

### BRIEF DESCRIPTION OF THE DRAWINGS

The specification drawings constituting one part of the present disclosure are used to provide a further understanding of the present invention. Illustrative embodiments and descriptions thereof of the present invention are used to explain the present invention, and do not constitute an improper limitation to the present invention. In the drawings:

FIG. 1 is a flow chart of controlling a lamp according to one embodiment of the present disclosure;

FIG. 2 is a flow chart of a lamp control system according to one embodiment of the present disclosure;

FIG. 3 is a circuit diagram of a signal receiving module according to one embodiment of the present disclosure;

FIG. 4 is a circuit diagram of a signal decoding module according to one embodiment of the present disclosure;

FIG. 5 is a circuit diagram of a received signal conversion module according to one embodiment of the present disclosure;

FIG. 6 is a circuit diagram of an AC signal processing module according to one embodiment of the present disclosure;

FIG. 7 is a circuit diagram of an AC signal sampling module according to one embodiment of the present disclosure;

FIG. 8 is a circuit diagram of a sampled signal processing module according to one embodiment of the present disclosure; and

FIG. 9 is a circuit diagram of lamp driving according to one embodiment of the present disclosure.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the described embodiments are only a part of the embodiments of the present disclosure, rather than all the embodiments. The following description of at least one exemplary embodiment is merely illustrative in nature and is in no way intended to limit the invention and its application or uses.

In order to keep the following descriptions of the embodiments of the present disclosure clear and concise, detailed descriptions of known functions and known parts are omitted in the present disclosure.

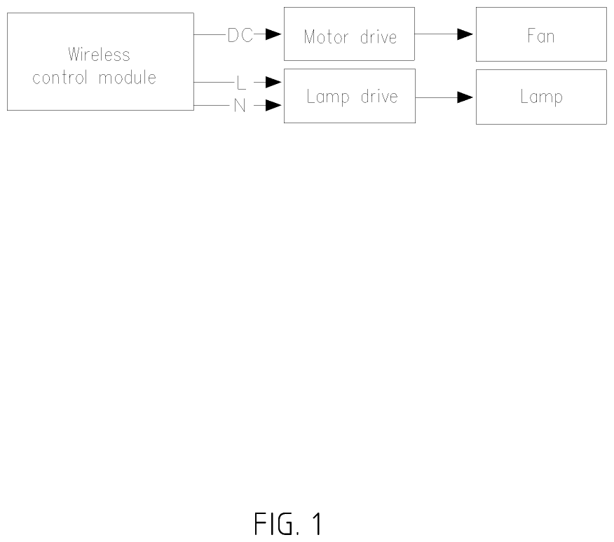

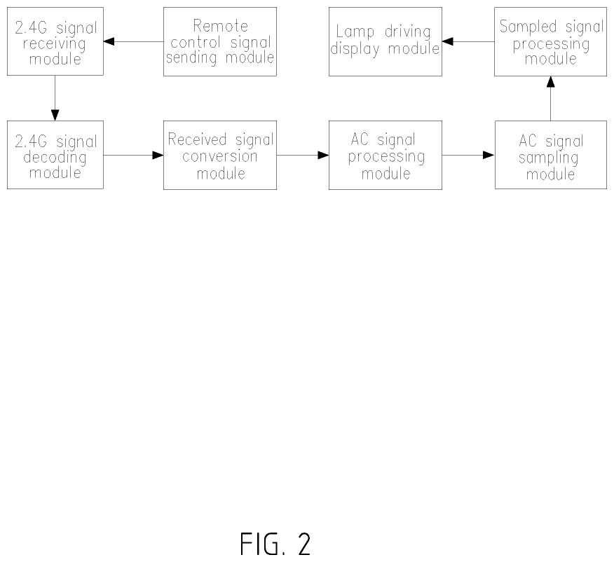

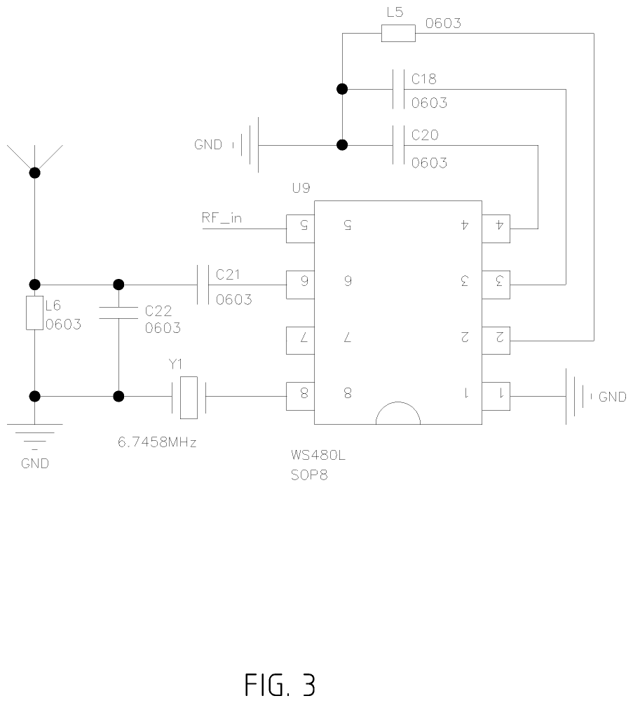

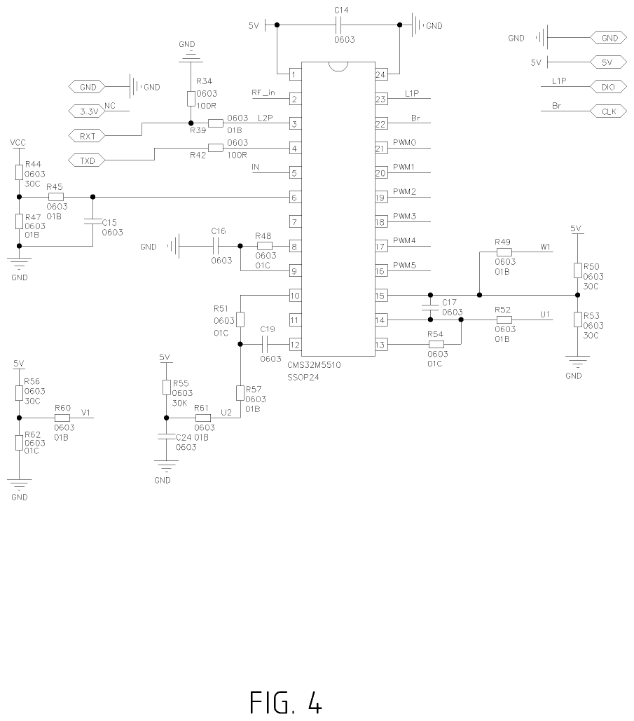

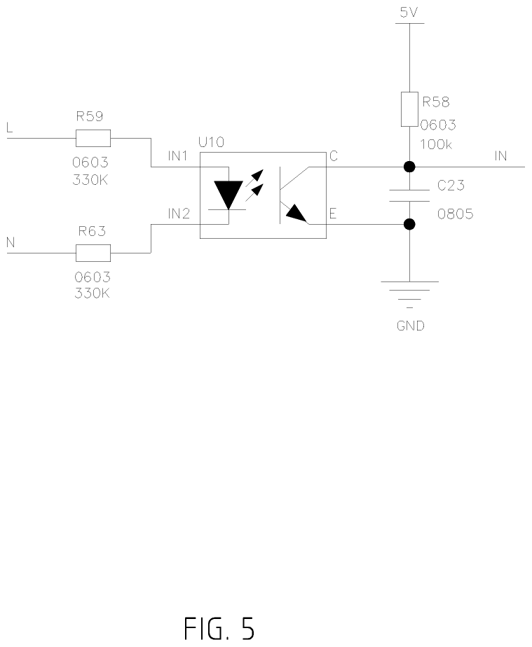

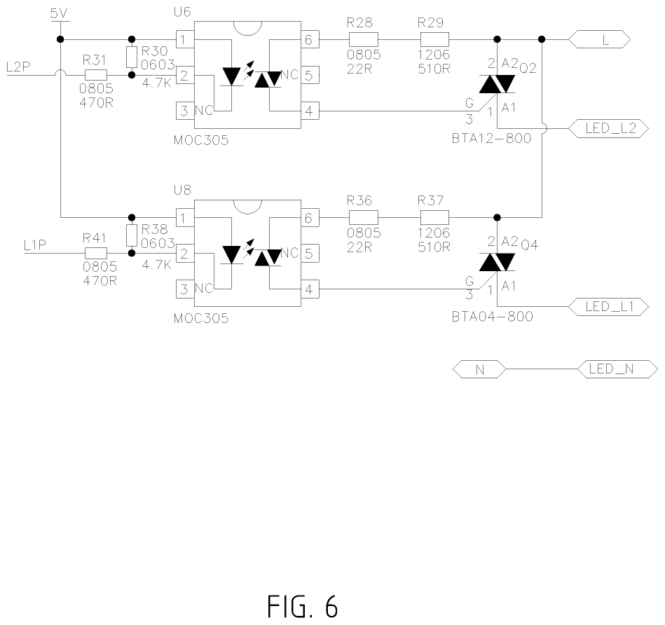

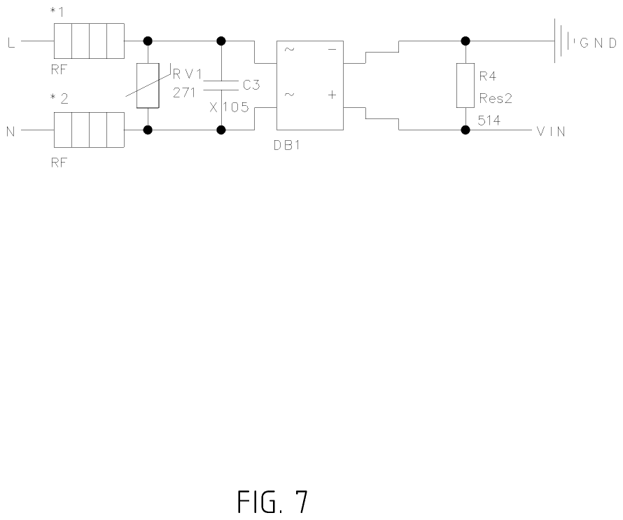

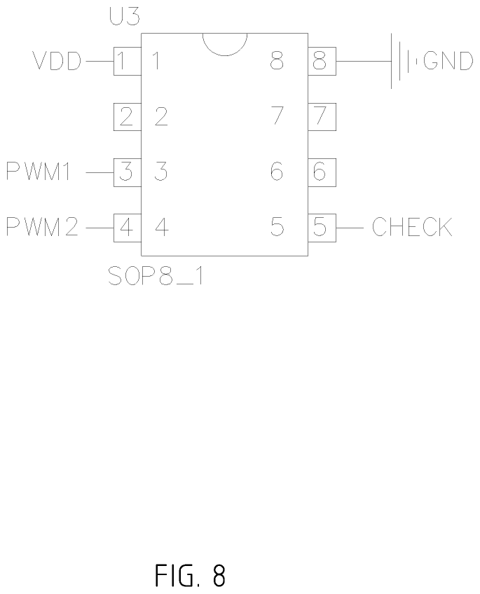

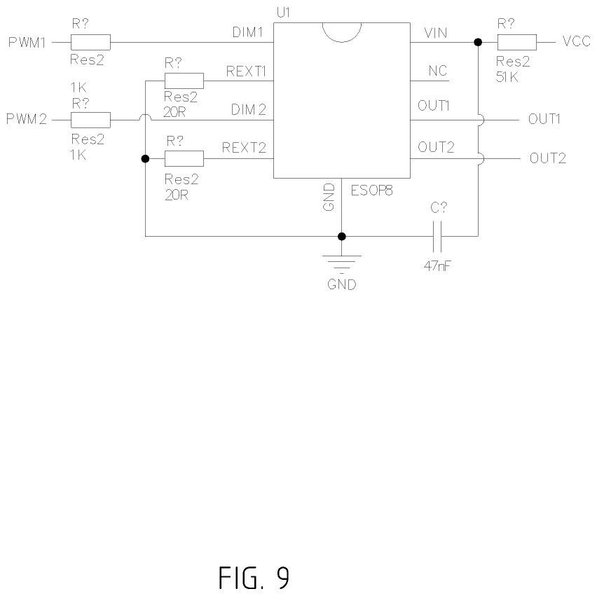

Referring to FIGS. 1-9, in this embodiment, a lamp with a remote control signal processing circuit is provided, including: a wireless control module, a motor driving module connected with the wireless control module, and a lamp driving module connected with the wireless control module. The lamp driving module is connected in parallel with the motor driving module.

In the present disclosure, received remote control signals are processed by one wireless receiving module in a unified manner, and an alternating-current (AC) signal is subjected to protocol control; and the AC signal is transmitted to the lamp driving circuit to adjust light, so that the cost is reduced, and the circuit volume is reduced. The present disclosure can convert the received remote control signals into protocol signals, and sample the AC signal through the protocol signals to generate a dimming control signal; and a color temperature level and luminous intensity of a lamp panel can be controlled without adding a remote control receiving and processing circuit on a lamp driving plate.

The wireless control module of this embodiment includes a remote control signal sending module.

The remote control signal sending module of this embodiment is connected with a signal receiving module; and the signal receiving module is connected with a signal decoding module.

The signal decoding module of this embodiment is connected with a received signal conversion module; and the received signal conversion module is connected with an AC signal processing module.

The AC signal processing module of this embodiment is connected with an AC signal sampling module; and the AC signal sampling module is connected with a sampled signal processing module.

The sampled signal processing module of this embodiment is connected with a lamp driving display module.

Specifically, the present disclosure is a lamp with a remote control signal processing circuit, which is applied to a fan lamp. For example, a wireless receiving and control module at the front end of the lamp driving module and a fan driving module are shared to perform a series of processing on a remote control signal and are connected with each other through power supply loops L and N, so that the brightness and color temperature of a lamp panel can be controlled without additionally adding a lamp panel signal control circuit.

A remote controller is pressed to send a corresponding fixed instruction signal sent, through a 2.4G radio frequency sending button, by the remote, control signal sending module; an antenna of the signal receiving module receives a 2.4G radio frequency instruction signal sent by the remote controller; and the signal decoding module decodes the remote control instruction signal. After decoding is completed, the received signal conversion module identifies the received remote control instruction; the remote control instruction is a 32-bit binary instruction code; a color temperature button and a brightness button correspond to different code values; the received signal conversion module needs to identify each button instruction, and converts, according to a given protocol, the signal for the corresponding instruction into 12 waveforms stipulated in the protocol; the color temperature button processes and outputs, through the received signal conversion module, 12 waveform instructions corresponding to different color temperature values; and the brightness button processes and outputs, through the received signal conversion module, 12 waveform instructions corresponding to different brightness values.

After receiving the signal of the received signal conversion module, the AC signal processing module performs phase-cutting processing on an AC signal. The phase-cutting processing is to cut off a wave band with a phase angle less than a set value, and the voltage of this wave band turns to zero. For example, an AC signal in the middle section of cursor A and cursor B, i.e., continuous alternating-current waveforms of 6 cycles, is divided into 12 continuous half-cycle waveforms; each half-wave corresponds to the 12 control waveforms output by the received signal conversion module in sequence; by means of a dimming output circuit, when a falling edge occurs in the waveforms output by the received signal conversion module, a corresponding half-wave signal is cut off from the falling edge to a wave band at the end of the half cycle; and when no falling edge occurs in the control waveforms output by the received signal conversion module, the whole half-wave corresponding to the AC signal are, maintained. By analogy, the AC signal is processed according to the 12 waveform instructions of the protocol. Apart from this, the AC signal is no longer processed. The processed AC signal carries a protocol signal for transmission while providing power, and no other signal transmission circuits need to be added. After the phase cutting is completed, full-wave rectification is performed through a rectifier bridge to rectify the AC signal into a direct-current (DC) signal.

After the rectification is completed, the received signal conversion module samples the rectified signal, and the rectified AC signals of 6 cycles are converted into 12 DC waveforms. Voltage drop is achieved through a divider resistor, such as a controller waveform detection circuit; the DC waveforms are input into a sampling and detection pin of a single-chip microcomputer; the single-chip microcomputer sets a certain voltage to be a dividing point between a high level and a low level; if an input waveform is higher than this voltage, it is a high level; and if the input waveform is lower than this voltage, it is a low level. The DC waveforms are converted into 12 rectangular waves through a pin of the single-chip microcomputer. At this time, the duty ratios of the rectangular waves corresponding to the waveforms of a phase-cut angle and a non-phase-cut angle are different. The rectangular wave having the duty ratio less than, a certain duty ratio is regarded as ‘0’, and the rectangular wave having the duty ratio greater than the certain duty ratio is regarded as ‘1’. A 12-bit binary number can be obtained. The 12-bit binary number is an instruction code that controls the color temperature and luminous intensity. Since a voltage input by a power grid will fluctuate, when the voltage input by the power grid fluctuates, the voltage input to the pin of the single-chip microcomputer by means of voltage drop through the divider resistor will change. If the dividing point, set by the single-chip microcomputer, between a high level and a low level is not changed according to a change of a peak value of the voltage input by the power grid, the duty ratio of the rectangular wave detected by the single-chip microcomputer will be abnormal, resulting in an, error in distinguishing between ‘0’ and ‘1’, which causes an error in the instruction code. At this time, the dividing point, set by the single-chip microcomputer, between a high level and a low level is changed in real time according to different peak voltages input by the power grid. The pin of the single-chip microcomputer will also sample and detect the peak value of the voltage of the power grid while sampling and detecting low level and high level inputs, so that the objective of still normal work when a high voltage is input is achieved.

After the sampled signal processing module has parsed the input instruction code, the single-chip microcomputer will perform internal operations. The first four bits of a 12-bit binary instruction code are used as color temperature instruction codes, and the last eight bits of the instruction code are used as luminous intensity instruction codes. The first bit of the first four bits of the instruction code is used as the header of the instruction and a start bit for input detection, and there are seven combinations for the last three bits, representing seven color temperatures. The last eight digits of the instruction code range from 0 to 255. Multiple levels of luminous brightness can be set.

### Example 1

A brightness +/− button of the remote controller is pressed; the remote control signal sending module sends a 2.4G radio frequency signal; the received signal receiving module receives the signal through the antenna, such as a wireless receiving part of the circuit; the signal then is input into a chip WS480L, and is converted into 32 rectangular waves by the chip. For example, the rectangular waves are subjected to binary value identification and conversion through the received signal conversion module. 32 rectangular wave signals correspond to 32 binary bits. A rectangular wave has two different duty ratios. The bit with the high duty ratio is ‘1’, and the bit with the low duty ratio is ‘0’. The received signal conversion module identifies the 32-bit binary value to determine functions of the buttons of the remote controller. If a brightness function on the remote controller is pressed, the received signal conversion module converts the instruction into 12 control waveforms through an internally set protocol and outputs the same every time it receives the instruction.

The AC signal processing module uses the signal output by the received signal conversion module to process the AC waveform. The 12 control waveforms output by the received signal conversion module correspond to 12 continuous half-cycle AC waveforms in time sequence; the AC waveform is subjected to phase cutting process according to the control waveform, such as a dimming output circuit. A thyristor controls turning-on and turning-off to cut a phase through the 12 control waveforms output by the received signal conversion module. The phase-cut angle of the half-wave is controlled at about 43°. After the phase cutting is completed, the AC signal is subjected to the full-wave rectification by the rectifier bridge to output 12 DC waveforms.

The received signal conversion module is a single-chip microcomputer with an analog-to-digital conversion function, which converts a voltage analog quantity into a digital quantity. A power supplying AC voltage has a valid value of 120 V and a frequency is 60 HZ. After the rectification, the frequency becomes 120 HZ. After the half-wave signal is subjected to voltage division by the divider resistor, a voltage range is 0-4 V; a tangential angle is 43°, and an approximate corresponding amplitude value is 2.73 V; and the set dividing point between a high level and a low level is 2.0 V. A difference between phase angle 2.0 V and phase angle 2.73 V is t0; t0 is a time difference between the duty ratios of the rectangular waves corresponding to the instruction codes ‘0’ and ‘I’. Through this time difference t0, whether each bit of the 12-bit instruction code is ‘0’ or ‘1’ can be distinguished. When the voltage of the power grid fluctuates, the voltage range of the half-wave signal will also change after the half-wave signal is subjected to voltage division by the divider resistor. A voltage division value corresponding to a peak voltage will fluctuate around 4 V, and the amplitude value corresponding to the tangential angle of 43° will also fluctuate in the same direction as the peak value. At this time, the voltage of the dividing point between a high, level and a low level should also be adjusted accordingly to ensure that the difference, between the phase angles is t0 and will not change too much, resulting in an error in identification of the instruction codes.

The AC signal processing module can set seven color temperatures according to the values of the last three bits in the first four bits of the 12-bit instruction code. The luminous intensity can be set according to the values of the last eight bits. Different color temperatures are achieved by adjusting the difference in the ratios of the luminous intensity of two lamp beads with color temperatures of 3000K and 6000K respectively. The ratios of the luminous intensity of 3000K and 6000K can be set to 50%, or the ratio of the luminous intensity of 3000K is set to 15% and the ratio of the luminous intensity of 6000K is set to 85% to achieve other levels of color temperatures. The value range of the last eight bits is 0-255, and there may be 51 luminous intensity levels in unit of 5 within this range. According to different color temperatures and luminous intensity levels, through the internal operation of the single-chip microcomputer, an output to two pins of the single-chip microcomputer is in the form of pulse width modulation (PWM) voltage signals with different duty ratios.

The received signal conversion module adjusts the magnitude of an output constant current value according to two PWM inputs with different duty ratios. For example, a constant current chip used now is SM2612EN. The current value controls the magnitudes of two output currents according to the PWM duty ratios input by two channels. Two light emitting diode (LED) lamp beads with different color temperatures have luminous color temperatures of 3000K and 6000K. The luminous intensity is controlled by controlling a current flowing through the two LEDs, and the ratios of the luminous intensity of the two LEDs are controlled to achieve corresponding color temperature levels.

The above embodiment may be combined with each other.

It should be noted that the terms “first”, “second”, etc. in the specification and claims of the present disclosure and the above drawings are used to distinguish similar objects, and do not have to be used to describe a specific order or sequence. It should be understood that data used in this way is interchangeable under appropriate circumstances so that the implementations of the present disclosure described herein can be implemented in an order other than those illustrated or described herein.

In the description of the present disclosure, it should be understood that orientations or positional relationships indicated by orientation terms such as “front, rear, upper, lower, left, right”, “transverse, vertical, perpendicular, horizontal”, “top, bottom”, etc are usually based on orientations or positional relationships shown in the drawings, which are only for the convenience of describing the present disclosure, and simplifying the description. In the absence of a statement to the contrary, these orientation terms do not indicate and imply that a device or element indicated need to have a specific orientation or be constructed and operated in a specific orientation, so they cannot be construed as a limitation to the protection scope of the present disclosure. The orientation terms “inside and outside” ° refer to the inside, and outside relative to the outline of each component itself.

What is claimed is:

1. A lamp with a remote control signal processing circuit, the lamp comprising a wireless control module, a motor driving module connected with the wireless control module, and a lamp driving module connected with the wireless control module, wherein the lamp driving module is connected in parallel with the motor driving module.

2. The lamp with the remote control signal processing circuit according to claim 1, wherein the wireless control module comprises a remote control signal sending module.

3. The lamp with the remote control signal processing circuit according to claim 2, wherein the remote control signal sending module is connected with a signal receiving module; and the signal receiving module is connected with a signal decoding module.

4. The lamp with the remote control signal processing circuit according to claim 3, wherein the signal decoding module is connected with a received signal conversion module; and the received signal conversion module is connected with an alternating-current (AC) signal processing module.

5. The lamp with the remote control signal processing circuit according to claim 3, wherein the AC signal processing module is connected with an AC signal sampling module; and the AC signal sampling module is connected with a sampled signal processing module.

6. The lamp, with the remote control signal processing circuit according to claim 5, wherein the sampled signal processing module is connected with a lamp driving display module.
